(19) United States
(12) Patent Application Publication
(10) Pub. No.: US 2008/0100725 A1
(43) Pub. Date: May 1, 2008

(54) CIRCUITS FOR ENHANCING YIELD AND PERFORMANCE OF CMOS IMAGING SENSORS

(76) Inventor: Wagdi W. Abadeer, Jericho, VT (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/553,608

(22) Filed: Oct. 27, 2006

(51) Int. Cl. H04N 5/217

(52) U.S. Cl. 348/241

(57) ABSTRACT

A system for replacing a defective pixels in a pixel array is presented. The system includes means for identifying a defective pixel in the pixel array, means for generating a code including information corresponding to the defective pixel row and column; means for decoding the information;, and means for generating a signal that permanently identifies the defective pixel row and column based on the decoded information. The system further includes means for substituting data from the defective pixel with data from a functioning pixel disposed in a same row as, and next to, the defective pixel based on the generated signal.

### FIELD OF THE INVENTION

The invention relates generally to the field of imaging sensors, and more particularly to circuits for enhancing yield and performance of CMOS imaging sensors.

### BACKGROUND INFORMATION

In devices employing optical imaging sensors, there are several possible sources for yield loss or degradation of the quality of the output optical images. One source of yield loss is defective pixels. Defective pixels can be caused by excessive dark current, defects causing bright point images, shorts, or general defects in silicon or metallization layers leading to distortions in the optical images.

FIG. 1 shows a prior art arrangement of Y rows and X columns of an active array 100 of pixels 106a-t. An array of pixels columns are activated by various signals including a transfer gate (TG) 122, a reset gate (RG) 124, and row select (RS) 125 and power supply Vdd 120 from a vertical (column) scan circuit 105 and an array of pixel rows are scanned for outputs by a horizontal (row) scan circuit 110. Outputs of pixels sharing the same row are delivered one by one to output buffer 130 by the column select transistors 115a-d which are activated through their gates from the column select circuit 105.

Other sources of optical image problems involve conduction and leakage characteristics of the pixel devices. It is also possible that there are defects in the lenses or optical filters, which could cause distortion in color images.

FIG. 2 shows a prior art schematic of a pixel. A pixel design could consist of a transfer device gate (TG) 202 and a reset device gate (RG) 204. The TG 202 is required to have a very low “OFF” current when the TG 202 of an NFET 206 is pulled to at ground (GND) so that this OFF current does not interfere with the photo current due to an image. Another source of image degradation is when the “OFF” current of the TG 202 is not low enough, and setting the TG 202 to some small negative value is required to reduce the “OFF” current to an acceptable value. This negative gate voltage unavoidably could cause additional leakage due to diffusion forward bias. Also, the TG 202 voltage and RG 204 voltages might be sufficiently high, at least for some pixels, causing pixel output 208 to deviate from expected values, given a certain value of incident radiation.

One solution to solve the problem of defective or partially defective pixels employs non-optical (dark) as well optical testing of the pixel array and determining locations of defective or partially defective pixels and the degree of their deviation from normal pixels. This solution also involves determining a required fix for bad data from defective pixels. This fix could involve masking the data of a bad pixel altogether, or replacing the data of a bad pixel by an average of the data from functioning neighboring pixels. The array testing could be employed prior to shipment (during manufacturing initial testing). However, the information regarding the defective pixels must be stored in a non-volatile memory. In addition, the pixel array testing could be done after shipment of product (by a customer). In this case, other types type of memory could be used, such as SRAM or DRAM for storing the information regarding the defective pixels. The testing requires both dark and optical testing, which could include color testing. These tests are built into the optical system, and employs injecting a certain amount of charge into a photo diode and determining if the response is within an expected value. These tests also requires applying incident radiation (optical testing) with a specific magnitude of the radiation. For implementation during lifetime use after product shipment, this testing would have to be applied every time the product (such as a camera) is used and the power is turned ON. Further, this solution requires a fault analysis and correction system that employs software for decision making regarding the defective pixels. Hence, this solution requires the use of memory, special features for array testing when the product is in use in the field by the customer, and the application of light with a specific amount of intensity as well as a certain color. Moreover, this solution requires a fault analysis and correction system to be included on the same chip as the pixel array or on a separate chip.

Another solution involves using specific incident light to activate a simple circuit associated with a few special pixels in addition to the normal active pixel array. The circuit is activated in conjunction with employing e-fuses, which replace defective capacitors with functioning capacitors, or disconnects electrostatic discharge (ESD) networks to improve performance.

### SUMMARY OF THE INVENTION

The invention relates generally to the field of imaging sensors, and more particularly to circuits for enhancing yield and performance of CMOS imaging sensors.

According to one aspect, the invention involves a system for replacing defective pixels in a pixel array. The system includes a means for identifying a defective pixel in the pixel array, a means for generating a code comprising information corresponding to the defective pixel row and column, a means for decoding the information, a means for generating a signal that permanently identifies the defective pixel row and column based on the decoded information, and a means for substituting data from the defective pixel with data from a functioning pixel disposed in a same row as, and next to, the defective pixel based on the generated signal.

In one embodiment, the means for identifying the defective pixel includes at least one a device for functional testing of the pixel array, a device for testing dark current, a device for optical testing, and a device for color testing. In another embodiment, the means for generating the code includes a code generator. In still another embodiment, the means for decoding the information includes a row decoder and a column decoder. In yet another embodiment, the means for generating a signal that permanently identifies the defective pixel row and column includes electronic fuses.

In other embodiments, the means for substituting data from the defective pixel with data from a functioning pixel disposed in the same row as, and next to, the defective pixel includes digital logic circuitry. In another embodiment, the functioning pixel is located to the right of the defective pixel in the same row. In still another embodiment, the functioning pixel is located to the left of the defective pixel in the same row.

According to another aspect, the invention involves a system for replacing a defective pixel in a pixel array. The system includes a means for identifying a defective pixel in the pixel array, a means for generating a code comprising information corresponding to the defective pixel row and column, a means for decoding the information, a means for generating a signal that permanently identifies the defective pixel row and column based on the decoded information, and a means for substituting data from the defective pixel based on the generated signal with an average of data from a first and a second functioning pixel disposed in a same row as the defective pixel, the first functioning pixel disposed on one side of the defective pixel, the second functioning pixel disposed on another side of the defective pixel.

In one embodiment, the means for identifying the defective pixel includes at least one a device for functional testing of the pixel array, a device for testing dark current, a device for optical testing, and a device for color testing. In another embodiment, the means for generating the code includes a code generator. In still another embodiment, the means for decoding the information includes a row decoder and a column decoder. In yet another embodiment, the means for generating a signal that permanently identifies the defective pixel row and column includes electronic fuses. In other embodiments, the means for substituting data from the defective pixel with an average of data from a functioning first pixel and a functioning second pixel includes digital logic circuitry.

According to still another aspect, the invention involves a method for replacing defective pixels in a pixel array. The method includes identifying a defective pixel in the pixel array, generating a code comprising information corresponding to the defective pixel row and column, decoding the information, generating a signal that permanently identifies the defective pixel row and column based on the decoded information, and substituting data from the defective pixel with data from a functioning pixel disposed in a same row as, and next to, the defective pixel based on the generated signal.

In one embodiment, identifying the defective pixel includes testing the pixel array with at least one of a device for functional testing of the pixel array, a device for testing dark current, a device for optical testing, and a device for color testing. In another embodiment, generating a signal that permanently identifies the defective pixel row and column includes implementing electronic fuses based on the decoded information. In still another embodiment, the functioning pixel is located to the right of the defective pixel in the same row. In yet another embodiment, the functioning pixel is located to the left of the defective pixel in the same row.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. In addition, the drawings are not necessarily to scale, emphasis instead generally being placed upon illustrating the principles of the invention.

FIG. 1 is an illustrative prior art arrangement of Y rows and X columns of an active pixel array.

FIG. 2 is an illustrative prior art schematic of a pixel.

FIG. 3 is an illustrative flow diagram of a function test employing e-fuse technology for identifying defective pixel rows and columns, according to one embodiment of the invention.

FIG. 4 is an illustrative schematic diagram of code signal processing circuit for identifying defective pixel rows and columns, according to one embodiment of the invention.

FIG. 5A is an illustrative schematic diagram of an implementation of a circuit for replacing the output of a defective pixel (column 1, row 1) with the output of a neighboring pixel (column 2, row 1), according to one embodiment of the invention.

FIG. 5B is an illustrative truth table (Table 1) for a pixel in row one, column one (pixel 1) of FIG. 5A.

FIG. 6A is an illustrative schematic diagram of another implementation of a circuit for replacing the output of a defective pixel (column 1, row 1) with the output of a neighboring pixel (column 2, row 1), according to another embodiment of the invention.

FIG. 6B is an illustrative truth table (Table 2) for a pixel in row one, column one (pixel 1) of FIG. 6A.

FIG. 7A is an illustrative schematic diagram of a portion of the circuit of FIG. 6A for replacing the output of a defective pixel (column 2, row 1) with an average of the output of neighboring pixels (columns 1 and 3, row 1).

FIG. 7B is an illustrative truth table (Table 3) for a pixel in row one and column two (pixel 2) of FIG. 7A.

FIG. 8 is an illustrative schematic diagram of a 4×4 pixel array connected to a circuit for replacing defective pixels, according to one embodiment of the invention.

### DESCRIPTION

The invention relates generally to the field of imaging sensors, and more particularly to circuits for enhancing yield and performance of CMOS imaging sensors. The present invention involves employing circuits separate from, and in communication with, a pixel array. The present invention also involves employing e-fuse technology.

The invention involves, before shipment, full functional testing of the pixel array, dark current and optical testing, and color testing. These tests are performed on a test system where each pixel is illuminated with light of a certain wavelength and intensity. A system of row and column decoders is employed to address each pixel in the pixel array. The required signals, such as reset, transfer device gate, and row select are applied by drivers connected to the pixel array. The output from each pixel is measured and identified. These initial tests identify bad or defective pixels and, with use of e-fuse technology, generate special signals for permanent identification of the defective rows and columns in a pixel array. The circuits of the present invention are external to, and interface with, any pixel array. The circuits are intended to be built into whatever device houses the pixel array. The built in circuits replace the data of every defective pixel with data of neighboring functioning pixels that share the same row as the defective pixel. This is possible because the data from all pixels sharing the same row all appear at the same time.

The present invention eliminates need for memory, fault analysis, and correction systems and associated software. The present invention also eliminates the need for optical, as well as non-optical, testing of the device (e.g. digital camera, digital camcorder, etc.) every time a user uses the device.

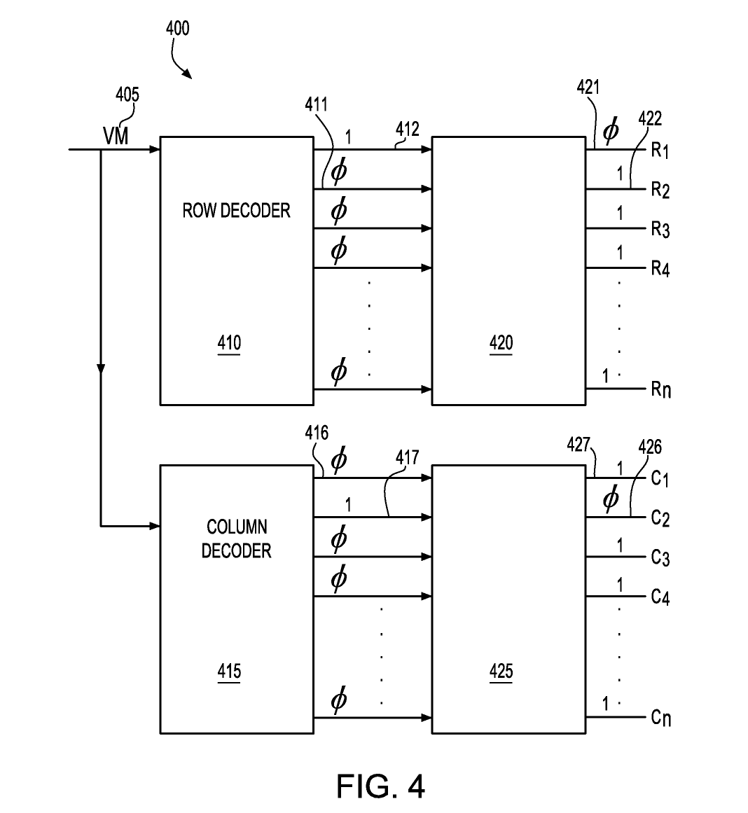

Referring to FIG. 3, in one embodiment, a flow diagram of a function test employing e-fuse technology for identifying defective pixel rows and columns is shown. A full functional test is conducted on each chip prior to shipment (Step 305). This functional test is complete with optical testing included to determine any problems in the pixel operation. From this testing, defective pixels are identified by their rows and columns (Step 3 10). From this information, a VM code signal is generated using latches and counters by methods known to those skilled in the art (Step 315). The VM code signal includes information regarding defective rows and defective columns and can be represented as a string of “0”s and “1”s. The VM code can be an eight bit signal for large pixel arrays. The VM signal is then supplied to pixel row and column decoders (Step 320).

Referring to FIG. 4, in one embodiment, a schematic diagram of a VM code signal processing circuit 400 for identifying defective pixel rows and columns is shown. Code signal VM 405 is input to row decoder 410 and column decoder 415 where “0” or “1” information is generated to identify defective rows and defective columns. A “0” 411, 416 indicates a functioning row or column, and a “1” 412, 417 indicates a bad row or column. In order to make this information permanent, electrical fuses (e-fuses) 420 are implemented for the defective rows to generate permanent signals that identify the defective rows from rows R1, R2, R3, . . . Rn by a “0” output 421 and leave the functioning rows alone by a “1” output 422. Electrical fuses 425 are also implemented for the defective columns to generate permanent signals that identify the defective columns from columns C1, C2, C3, . . . Cn by a “0” output 426 and leave the functioning columns alone by a “1” output 427.

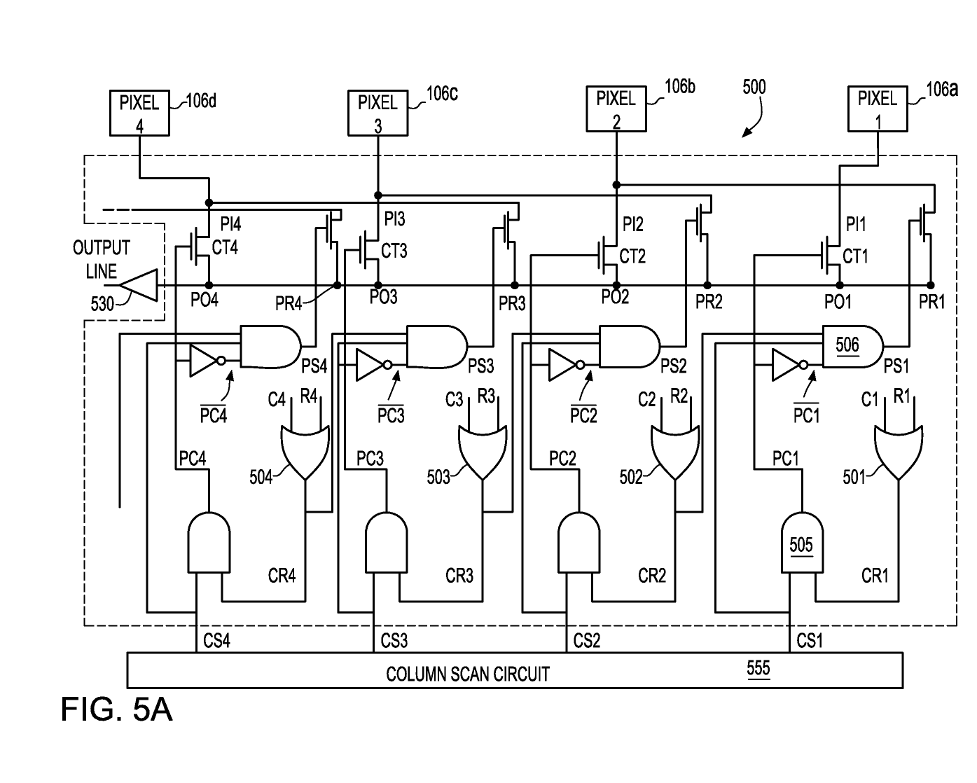

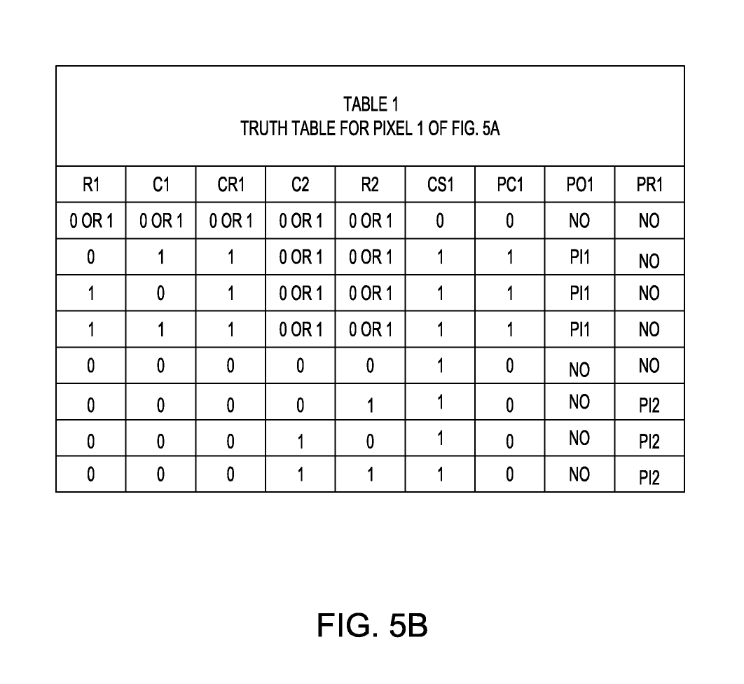

Referring to FIG. 5A, in one embodiment, a schematic diagram of an implementation of a circuit 500 for replacing the output of a right most defective pixel 106a (column 1, row 1) by the output of a neighboring (left side) pixel 106b (column 2, row 1) (if that pixel is functioning) is shown. In another embodiment, circuit arrangements could be made for replacing the output of a bad pixel by the output of the pixel on right side of the defective pixel. The output C1 and R1 of the VM code signal processing circuit 400 is connected to OR gate 501. The output C2 and R2 of the VM code signal processing circuit 400 is connected to OR gate 502. The output C3 and R3 of the VM code signal processing circuit 400 is connected to OR gate 503. The output C4 and R4 of the VM code signal processing circuit 400 is connected to OR gate 504.

For pixels sharing the right most (far right) column, a bad pixel is replaced only by the output of the pixel in the next column to the left and sharing the same row with the bad pixel. Similarly, for pixels sharing the left most column (far left), a bad pixel is replaced only by the output of the pixel in the next column to the right and sharing the same row with the bad pixel. This arrangement for replacement of a bad pixel with data from neighboring pixel is possible because the data from all pixels sharing the same row are output at the same time.

Referring to FIG. 5B, in one embodiment, a truth table (Table 1) for a pixel in row one and column one (pixel one 106a) in FIG. 5A. As previously described, C1 and R1 are the outputs of the VM code signal processing circuit 400 for column one, row one. CS1 is the column scanning signal for column one output by a column scanning circuit 555. PC1 is the output of AND gate 505. PS1 is the output of AND gate 506.

When CS1 is low, the column associated with pixel one 106a is not selected by the column scanning circuit 555. The outputs PC1 of AND gate 505 and the output of AND gate PS1 506 are both low, and thus the nodes PR1 and PO1 are in a NO state, which means no output, or floating points. In this case no outputs are transferred to the OUTPUT LINE 530.

When the column associated with pixel one 106a is selected by the column scan circuit 555, then CS1 is high and the transfer of signal data from pixel one 106a can take place. If either of C1 or R1, or both, are high, which means that pixel one 106a is functioning, then node CR1 is high, and thus node PC1 is high and the pixel one 106a output PI1 is transferred to node PO1, and hence to the OUTPUT LINE 530. At the same time, node PS1 is low and the output of pixel two 106b is not transferred to node PR1 (i.e. output of pixel one 106a). In other words, the output of pixel one 106a is not replaced by the output of pixel two 106b.

If pixel one 106a is bad, then both R1 and C1 are low and nodes CR1 and PC1 are both low. In this case, the pixel one 106a output PI1 is not transferred to node PO1 or the OUTPUT LINE 530. At the same time, if pixel two 106b is functioning (i.e. either C2 or R2 or both are high), PS1 will be high and the pixel two 106b output PI2 is transferred to the OUTPUT LINE 530 to replace of the output of pixel one 106a.

For color imaging, a certain color filter is associated with each pixel (e.g., green, blue, or red filter). In such a situation, neighboring pixels on same row may not necessarily have the same type of color filter. For this situation the data of a bad pixel should be replaced by data of neighboring pixels on the same row but with the same type of color filter. The circuit shown in FIG. 5 can be easily modified so that the data of a bad pixel is replaced only by functioning data from a neighboring pixel, sharing same row, and with the same type of color filter. The truth tables and operation for other pixels (106b, 106c, 106d) in FIG. 5A, are very similar to that described for pixel one 106d.

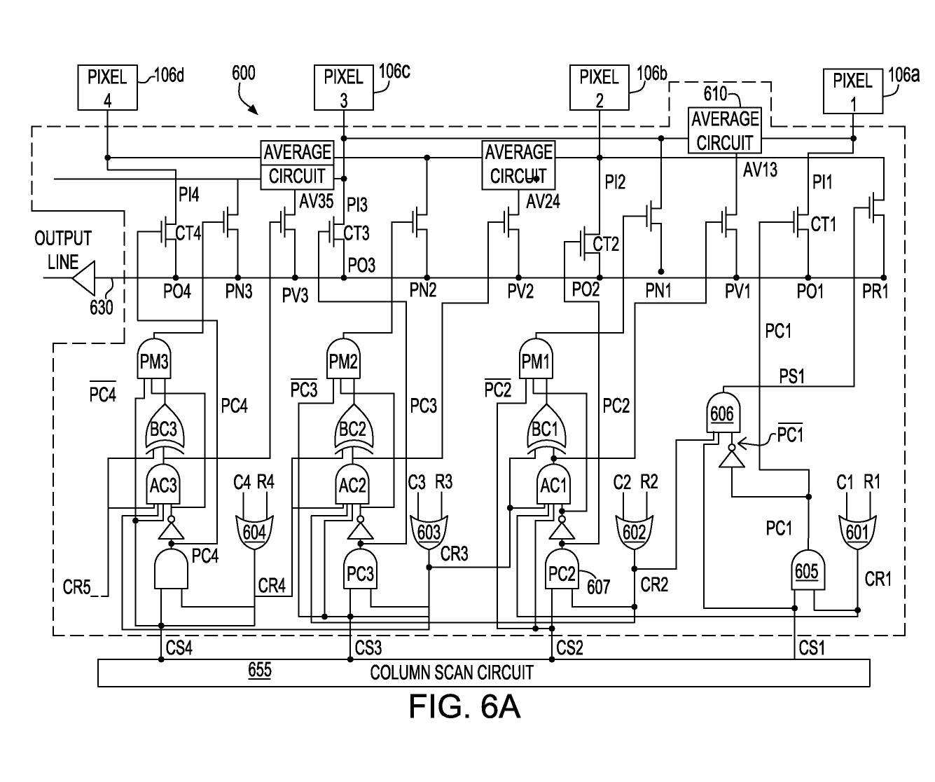

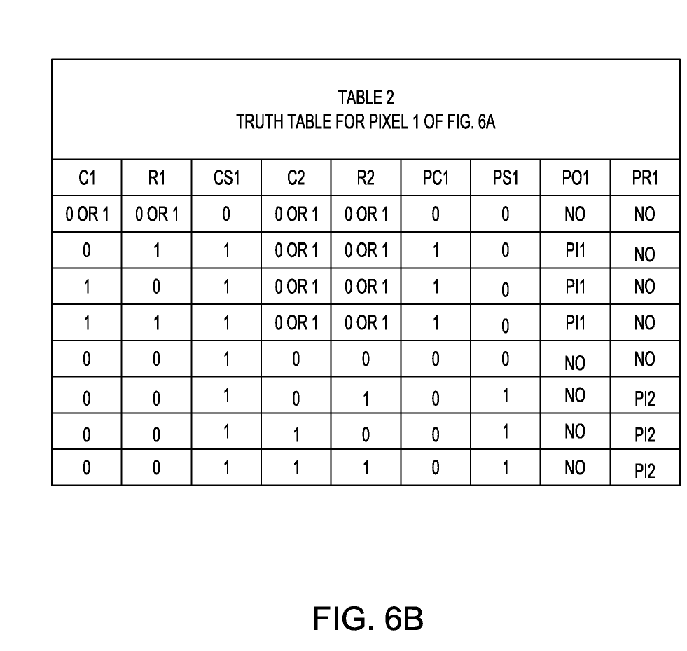

Referring to FIG. 6A, in another embodiment, a schematic diagram of another implementation of a circuit for replacing the output of a defective pixel (column 1, row 1) with the output of a neighboring pixel (column 2, row 1) is shown. For pixels sharing the right most column (i.e., column one), a defective pixel (e.g., 106a) is replaced only by the output of the pixel in the next column to the left (i.e., column two) and sharing the same row with the defective pixel (e.g., pixel two 106b). Similarly, for pixels sharing the left most column (i.e. column four), a bad pixel is replaced only by the output of the pixel in the next column to the right and sharing the same row with the defective pixel (such as pixel 106c, for example). This arrangement for replacing data from a defective pixel with data from a neighboring pixel is possible because the data from all pixels sharing the same row are output at the same time.

Referring to FIG. 6B, in one embodiment, a truth table (Table 2) for a pixel in row one, column one (pixel 1) of FIG. 6A is shown. As previously described with respect to FIG. 5A, C1 and R1 are the outputs of the VM code signal processing circuit 400 for column one, row one. C2 and R2 are outputs of the VM code signal processing circuit 400 for column two, row two, etc. PI1 is the output from pixel one 106a, and node PO1 is equal to PI1 when the control transistor CT1 is activated with gate PC1 high. In this case, the pixel one 106a output PI1 is transferred to OUTPUT LINE 630.

If the gate PC1 of transistor CT1 is low, then transistor CT1 is OFF, and pixel one 106a output PI1 is not transferred to node PO1. In this case, PO1 is referred to as NO, which means no output (i.e. PO1 is a floating point). If pixel one 106a is defective, the pixel one 106a output PI1 is not transferred to the OUTPUT LINE 630, and is replaced by the pixel two 106b output PI2, if pixel two 106b is functioning. In this case, the pixel one 106a output PI 1 is replaced by the pixel two 106b output PI2 which is transferred to node PR1 and hence the to the OUTPUT LINE 630 when the output PS1 of gate 606 is high. If both pixels 106a and 106b (pixels 1 and 2) are bad, then both PI1 and PI2 are not transferred to the OUTPUT LINE 630, and there is no replacement of the output of pixel 106a (pixel 1).

When the column of pixel 106a (pixel 1) is not activated by the column scan circuit 655, then output CS1 is low and so are the outputs PC1 and PS1 of gates 605 and 606, respectively. In this case, both nodes PR1 and PO1 are in a NO state and nothing is transferred for pixel 106a (pixel 1) to the OUTPUT LINE 630. If pixel 106a (pixel 1) is functioning, C1 or R1, or both, are high (CR1 is high), then the output PC1 of gate 605 is high, and the output PI1 of pixel 106a (pixel 1) is transferred to the OUTPUT LINE 630. Also in this case, node PS1 is low, node PR1 is in NO state, and the output PI1 of pixel 106a (pixel 1) is not replaced by the output PI2 from pixel 106b (pixel 2). If both C1 and R1 are low (CR1 is low), then pixel 106a (pixel 1) is defective, node PC1 is low, node PO1 is in NO state, and the output PI1 of pixel 106a (pixel 1) is not transferred to OUTPUT LINE 630.

When pixel 106a (pixel 1) is defective, but pixel 106b (pixel 2) is functioning (either R2, C2 or both are high), then node PS1 is high and the output PI1 of pixel 106a (pixel 1) is replaced by the output PI2 of pixel 106b (pixel 2), which is then transferred to node PR1 and hence to the OUTPUT LINE 630. If both pixels 106a and 106b (pixels 1 and 2) are defective, both node PC1 and node PS1 are low and the both the outputs PR1 and PO1 are in a NO state and nothing for pixel 106a (pixel 1) is transferred to the OUTPUT LINE 630. Note that CS1 from the column scan circuit 655 is input to both the AND gate 605 (which has output PC1) and AND gate 606. Therefore, the output PS1 of gate 606 cannot be high when CS1 is not high (i.e., the column of pixel 1 is not activated).

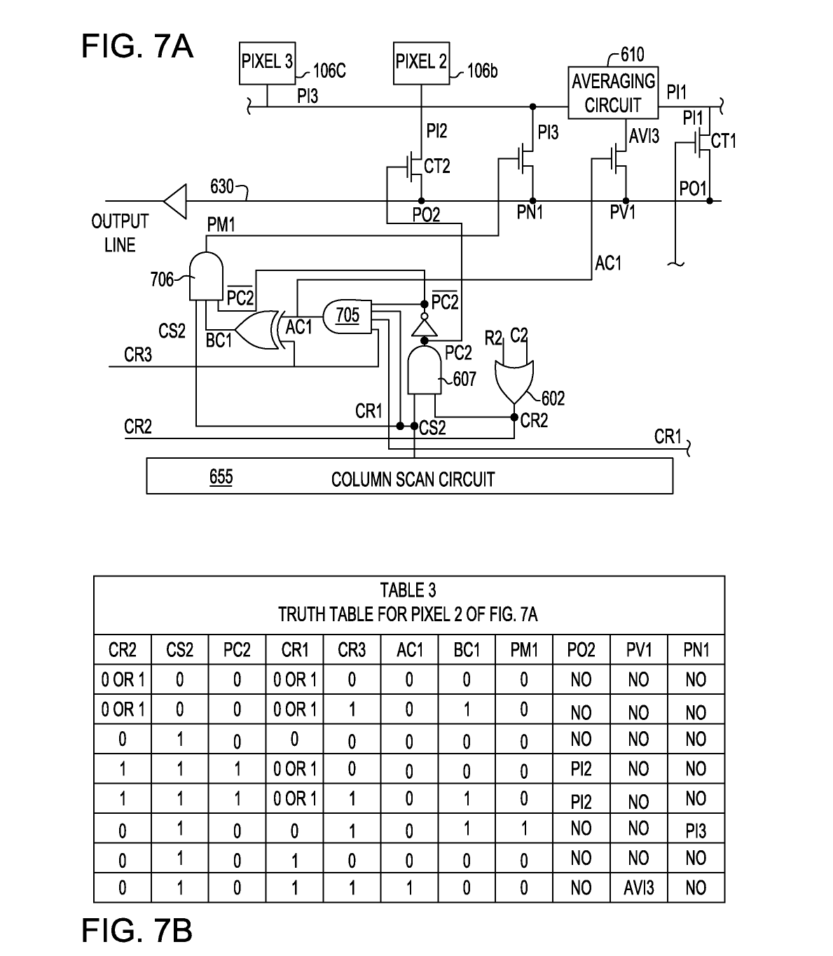

Referring to FIG. 7A, in one embodiment, a schematic diagram of a portion of the circuit of FIG. 6A for replacing the output of a defective pixel (column 2, row 1) with an average of the output of neighboring pixels (columns 1 and 3, row 1) is shown. FIG. 7B is a truth table (Table 3) for a pixel in row one and column two (pixel 2) of FIG. 7A.

The output PI2 of pixel 106b is transferred to PO2 and to the OUTPUT LINE 630 when the output PC2 of gate 607 is high and pixel 106b is functioning. AV13 is the output from an averaging circuit 610, which produces the average of the outputs of pixels 106a and 106c (pixels 1 and 3), i.e., the average of PI1 and PI3. AV13 is transferred to node PV1 and thus to the OUTPUT LINE 630 when the output AC1 of gate 705 is high. In this case, pixel 106b (pixel 2) has to be defective and both pixels 106a and 106c (pixels 1 and 3) have to be functioning.

In another case, the output P13 pixel 106c is transferred to node PN1 and hence to the OUTPUT LINE 630 when the output PM1 of gate 706 is high. In this case, pixels 106a and 106b have to be defective, but pixel 106c has to be functioning. If both pixels 106b and 106c are defective, regardless of the state of the output of pixel 106a, all the nodes PO2, PV1, and PN1 are in the NO state (i.e., no output), and nothing is transferred to the OUTPUT LINE 630 for pixel 106b.

Note that, for those skilled in the art, similar circuits to those shown in FIGS. 6A and 7A can be constructed to replace the output of pixel 106b (when pixel 106b is defective) by the output of pixel 106a (instead of pixel 106c) when pixel 1 is functioning. In other words, the circuits shown in FIGS. 6A and 7A can be designed to have the output of a defective pixel replaced by the output of the pixel on the right (if that pixel is functioning) when only the pixel on the right is functioning but not both the pixels on the right and left of the defective pixel are functioning.

Referring to the truth table shown in FIG. 7B (Table 3), if CS2 is low (i.e., the column associated with pixel 106b is not selected by the column scan circuit 655), the output nodes PC2, AC1, and PM1 are all low, and the nodes PO2, PV1 and PN1 are all at a NO state (i.e., floating). In this case, no signals are transferred to the OUTPUT LINE 630. With node CS2 high, the column of pixel 106b is activated and the transfer of data from pixel 106b to the OUTPUT LINE 630 can take place. If pixel 106b is functioning, then either C2, R2, or both are high and node CR2 is high. In this case, node PC2 is high and control transistor CT2 is ON. The transistor CT2 transfers the output PI2 of pixel 106b to node PO2 and hence to the OUTPUT LINE 630. Further, when pixel 106b is functioning, the outputs nodes AC 1 and PM 1 are low, which means that the nodes PV1 and PN1 are floating in a NO state and no output from pixels 106a and 106c are transferred to the OUTPUT LINE 630. If pixel 106b is defective, both C2 and R2 are low and PC2 is low, which means that CT2 is OFF and the output PI2 of pixel 106b is not transferred to the node PO2 or to the OUTPUT LINE 630.

If when pixel 106b is defective, but both pixels 106a and 106c are functioning, AC1 is high and AV13, which is the average of outputs of pixels 106a and 106c (pixels 1 and 3) is transferred to node PV1 and hence to the OUTPUT LINE 630. At the same time, PM1 is low and the output PI3 of pixel 106c is not transferred to node PN1 or to the OUTPUT LINE 630. If pixel 106b is defective, and pixel 106c is functioning but pixel 106a is defective, then AC1 is low, which means that the average of pixels 106a and 106c (AV13) is not transferred to the OUTPUT LINE 630. Also at the same, the nodes BC1 and PM1 are both high, and the output signal PI3 of pixel 106c is transferred to node PN1, and hence to the OUTPUT LINE 630. As previously mentioned, if pixels 106b and 106c are defective, but pixel 106a is functioning, nothing is transferred for pixel 106b to the OUTPUT LINE 630.

Note that, for those skilled in the art, similar circuits to those shown in FIGS. 5A, 6A and 7A can be constructed to replace the output of pixel 106b (when pixel 106b is defective) by the output of pixel 106a (instead of pixel 106c) when pixel 1 is functioning and both pixels 106b and 106c are defective.

For color imaging, a certain color filter is associated with each pixel (e.g., a green, blue or red filter). In such a situation, neighboring pixels on a same row may not necessarily have the same type of color filter. For this situation the data of a defective pixel should be replaced by data of neighboring pixels on the same row but with the same type of color filter. The circuit shown in FIGS. 6A and 7A can be easily modified so that the data of a defective pixel is replaced only by data from a neighboring pixel, sharing the same row, and with the same type of color filter.

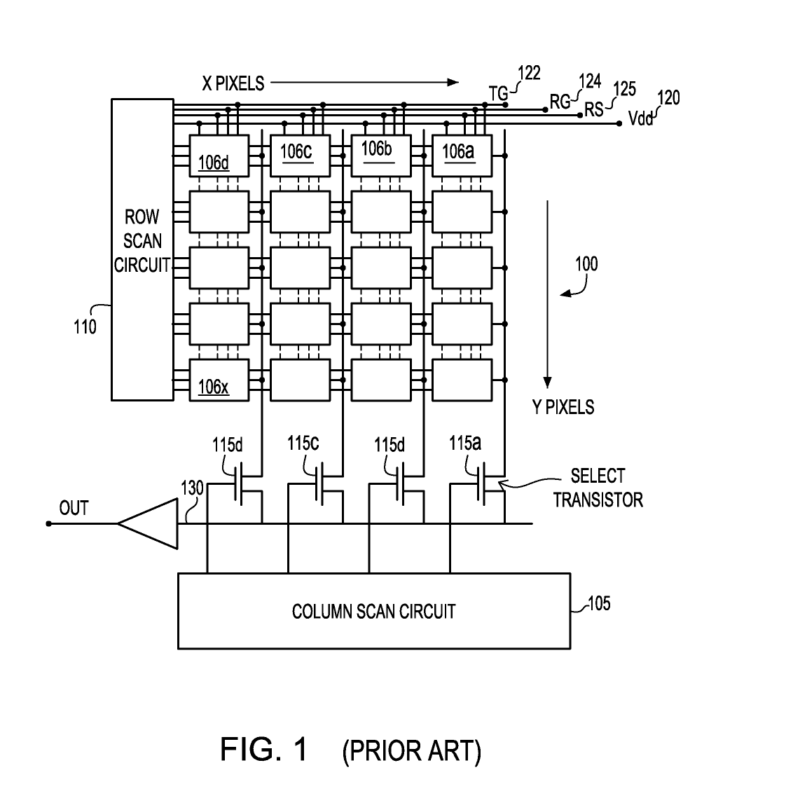

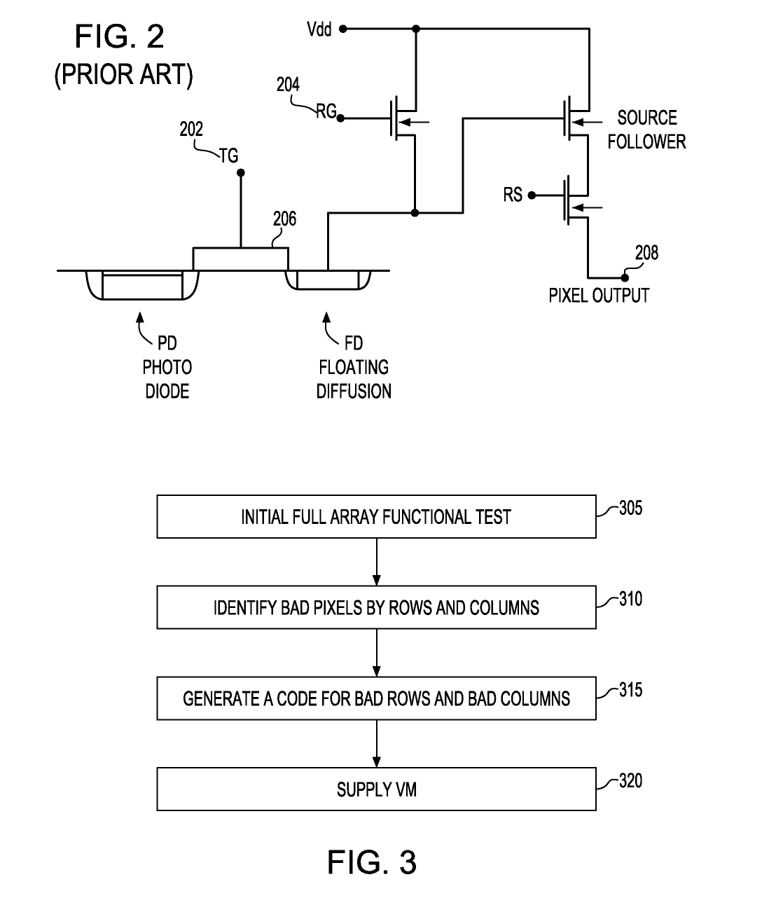

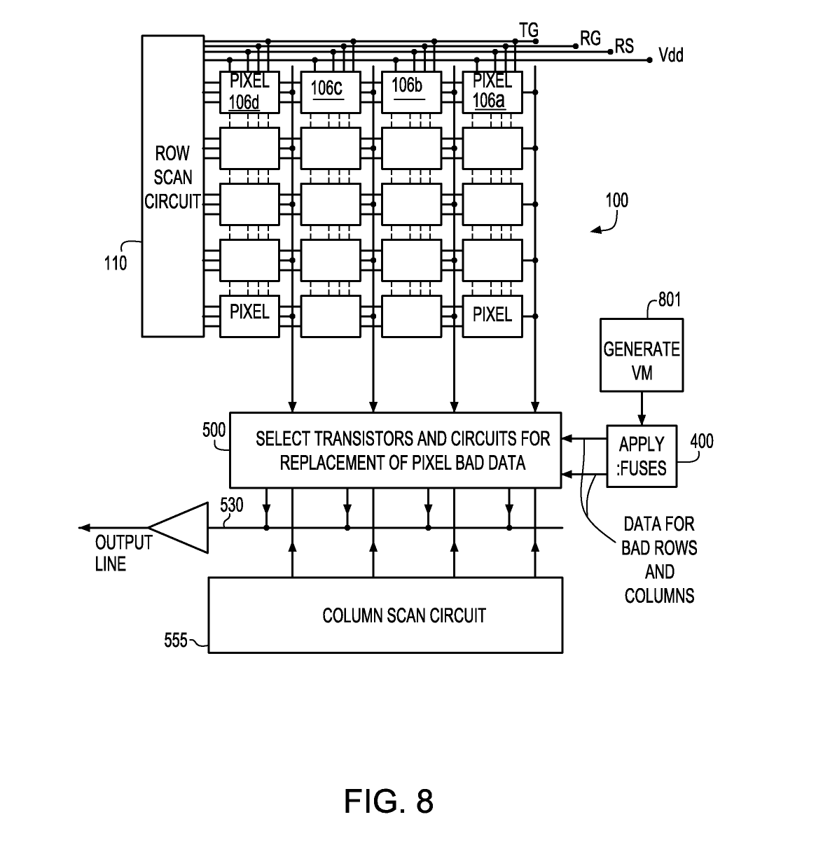

Referring to FIG. 8, in one embodiment, a schematic diagram of a 4×4 pixel array connected to a circuit for replacing defective pixels is shown. Comparing FIG. 8 to FIG. 1, the VM code signal generator 801 supplies the VM code signal to the VM code signal processing circuit 400. The VM code signal processing circuit 400 implements e-fuse technology to permanently generate column and row signals that are supplied to the circuit 500 for replacing defective pixels. The circuit 500 is disposed between the pixel array 100 and the column scan circuit 555. The combination of the VM code signal generator 801, the VM code signal processing circuit 400, the circuit 500 for replacing defective pixels, and the pixel array 100 has been described in detail hereinabove.

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A system for replacing a defective pixels in a pixel array comprising:
means for identifying a defective pixel in the pixel array;
means for generating a code comprising information corresponding to the defective pixel row and column;
means for decoding the information;
means for generating a signal that permanently identifies the defective pixel row and column based on the decoded information; and
means for substituting data from the defective pixel with data from a functioning pixel disposed in a same row as, and next to, the defective pixel based on the generated signal.

2. The system of claim 1 wherein the means for identifying the defective pixel comprises at least one a device for functional testing of the pixel array, a device for testing dark current, a device for optical testing, and a device for color testing.

3. The system of claim 1 wherein the means for generating the code comprises a code generator.

4. The system of claim 1 wherein the means for decoding the information comprises a row decoder and a column decoder.

5. The system of claim 1 wherein the means for generating a signal that permanently identifies the defective pixel row and column comprises electronic fuses.

6. The system of claim 1 wherein the means for substituting data from the defective pixel with data from a functioning pixel disposed in the same row as, and next to, the defective pixel comprises digital logic circuitry.

7. The system of claim 1 wherein the functioning pixel is located to the right of the defective pixel in the same row.

8. The system of claim 1 wherein the functioning pixel is located to the left of the defective pixel in the same row.

9. A system for replacing a defective pixel in a pixel array comprising:
a testing device for identifying a defective pixel in the pixel array;
a code generator circuit for generating a code comprising information corresponding to the defective pixel row and column;
a decoder device for decoding the information;
a signal generator for generating a signal that permanently identifies the defective pixel row and column based on the decoded information; and
a logic circuit for substituting data from the defective pixel based on the generated signal with an average of data from a first and a second functioning pixel disposed in a same row as the defective pixel, the first functioning pixel disposed on one side of the defective pixel, the second functioning pixel disposed on another side of the defective pixel.

10. The system of claim 9 wherein the testing device for identifying the defective pixel comprises one or more of: a device for functional testing of the pixel array, a device for testing dark current, a device for optical testing, and a device for color testing.

11. The system of claim 9 wherein the decoder device for decoding the information comprises a row decoder and a column decoder.

12. The system of claim 9 wherein the signal generator for generating a signal that permanently identifies the defective pixel row and column comprises electronic fuses.

13. The system of claim 9 wherein the logic circuit for substituting data from the defective pixel with an average of data from a functioning first pixel and a functioning second pixel comprises digital logic circuitry.

14. A method for replacing a defective pixels in a pixel array comprising:
identifying a defective pixel in the pixel array;
generating a code comprising information corresponding to the defective pixel row and column;
decoding the information;
generating a signal that permanently identifies the defective pixel row and column based on the decoded information; and
substituting data from the defective pixel with data from a functioning pixel disposed in a same row as, and next to, the defective pixel based on the generated signal.

15. The method of claim 15 wherein identifying the defective pixel comprises testing the pixel array with at least one of a device for functional testing of the pixel array, a device for testing dark current, a device for optical testing, and a device for color testing.

16. The method of claim 15 wherein generating a signal that permanently identifies the defective pixel row and column comprises implementing electronic fuses based on the decoded information.

17. The method of claim 15 wherein the functioning pixel is located to the right of the defective pixel in the same row.

18. The method of claim 15 wherein the functioning pixel is located to the left of the defective pixel in the same row.
